(19) United States
(12) Patent Application Publication
(10) Pub. No.: US 2021/0040647 A1
(43) Pub. Date: Feb. 11, 2021

(54) SYNTHETIC FIBER WITH ADDITION OF NATURAL MATERIAL AND METHOD OF ITS PRODUCTION

(71) Applicant: BJV RESEARCH, S.R.O., Bratislava (SK)

(72) Inventors: Branko Jass, Vtacnikom (SK); Jan Tomas, Bratislava (SK); Valer Kokos, Bratislava (SK)

(73) Assignee: BJV RESEARCH, S.R.O., Bratislava (SK)

(21) Appl. No.: 17/045,202

(22) PCT Filed: Apr. 4, 2019
(86) PCT No.: PCT/IB2019/052754

§ 371 Date: Oct. 5, 2020

(30) Foreign Application Priority Data
Apr. 6, 2018 (SK) PUV 50034-2018

(51) Int. Cl. D01F 1/10; D01F 6/06; D01F 6/18; D01F 6/60; D01F 6/62

(52) U.S. Cl. CPC D01F 1/10; D01F 6/06; D01F 6/62; D01F 6/60; D01F 6/18

(57) ABSTRACT

The volume content of the natural material in the resulting volume of the synthetic fiber (1) ranges from 0.5% to 45%. The natural material is milled into the form of particles (2) which have irregular shape with length differing from the width, whereby length (L) of the particle (2) of the natural material has a value ranging from 10% to 120% of the diameter of the synthetic fiber (1) and the width (W) of the particle ranges from 25% to 75% of the length (L) of the particle (2). At the same time the width (W) of the particle (2) does not surpass 50% of the cross-sectional diameter (D) of the synthetic fiber (1). Hemp, jute, linen, cotton, sisal, kenaf, wood, cellulose, lignocellulose, coconut, nut shells, starch, wheat, zeolite can be used as a natural material. The basic synthetic polymer component includes at least one thermoplastic polymer, for example polyolefin, such as polyethylene PE or polypropylene PP. Before the fiberization the natural material in form of milled particles (2) is added into the melt and subsequently the mixture of the basic material and particles (2) of the natural material are mixed at least for 5 minutes.

### CROSS REFERENCE TO RELATED APPLICATION

This application is a national stage entry of PCT/162019/052754 filed Apr. 4, 2019, under the International Convention and claiming priority over Slovakia Patent Application No. PUV 50034-2018 filed Apr. 6, 2018.

### FIELD OF TECHNOLOGY

The invention concerns a method of insertion or adding of the natural material during the production of the synthetic fiber, which achieves new characteristics of the synthetic fiber and also the cloth produced from such fiber. The synthetic fiber with the addition of natural material itself is also subject of this invention.

### PRIOR STATE OF THE ART

Synthetic fibers, for example, on the basis of polyester, polyamide, polypropylene are used in the textile industry; the have excellent thermal insulation characteristics, they are light and cheap. The textiles woven from synthetic fibers feel artificial to touch, they are electrostatic and can cause allergic skin reactions. The endeavor to imitate natural fibers such as cotton, wool, linen, silk have led to addition of natural fibers to the basic synthetic material. The conditions of production of synthetic fibers are unfavorable for the preservation of the characteristics of the natural fibers. The high temperature and pressure cause a degeneration of natural fibers; these often burn, carbonize and their influence in the resulting fiber disappears.

Publication CN107325505 discloses a textile material into which multiple natural materials, such as coconut fibers or bamboo fibers, are added. The thermally stabilizing substance is part of the mixture.

File AU2007361791 concerns the method of production of the synthetic fiber where the microcapsules in ratio ranging from 5% to 50% of the mass are added to basic material. The microcapsules contain plant oil. The fibers and textiles from these fibers smell of plants.

The file pursuant to CZ29526U1 discloses the addition of the fibers of the cellulose or coconut to the composite for production of the injected plastic components. Such solution without use for the fibers where small diameter is desired, for example for the weaving of the cloths. Solution pursuant to CZ20110852 which uses the fibers of wood pulp has similarly limited usefulness.

Publication EP 3342902 A1 discloses synthetic fiber with the addition of plant extract in the share ranging from 0.1 to 30% of the mass, where the particles have a diameter smaller or identical to 100 μm. File US 20130034620 A1 discloses a method of addition of plant particles during the production of fibers. The active substances of the plant extract degrade during the effects of the high temperature and the resulting features of the resulting fiber are affected by the plant extract only to small degree.

The file according to SK 942015U1 discloses the addition of fine cellulose with a particle size ranging from 6 to 12 μm in ration of 1 to 20% of the mass to the polpropylene carrier for the preparation of the fibers for the textile products. The fibrous basis of the added natural material manifests itself on the outer surface of the resulting fiber only to small degree.

Other publications such as WO2017183009, CN103255487, CA2647567 disclose addition of various natural fibers to the basic material of the synthetic fiber. The disadvantage of the known methods is low effectivity of the use of the natural material, which is degraded during the production, and which manifests itself on the surface of the synthetic fiber in the resulting form only to small degree. Such solution is desired and not known which will significantly improve the use values of the synthetic fiber, mainly its features for transfer and regulation of the humidity, whereby the strength features of the synthetic basis are preserved.

### SUMMARY OF THE INVENTION

The abovementioned deficiencies are significantly remedied by the synthetic fiber with the admixture from the natural material, where the synthetic fiber involves polymer in form of the fiberized basic material, and where the natural material has a form of separate particles, which are present in the basic material according to this invention which essence lies in the fact that the volume content share of the natural material in the resulting volume of the synthetic fibers ranges from 0.5% to 45%. A share ranging from 1% to 15% in relation to the resulting use features has proved preferable. Pursuant to the density of the natural material the mentioned volume percentages may be equal to the mass percentages.

The separate particles of the natural material have an irregular shape which manifests itself by different outer dimensions in various directions; the separate particles of the natural material usually have a length different from the dimension in the direction perpendicular on the dimension of the length. The larger dimension of the particle of the natural material has a value ranging from 10% to 120% of the cross-sectional diameter of the resulting synthetic fiber and the smaller dimension of the particle of the natural material has a value ranging form 25% to 75% of the larger dimension of the particle, whereby it does not surpass 50% of the cross-sectional diameter of the synthetic fiber. In a preferable arrangement the larger dimension of the particle of the natural material ranges from 30% to 80% of the cross-sectional diameter of the resulting synthetic fiber. The larger dimension of the particle of the natural material can be considered a length of the particle, the smaller diameter or the diameter oriented perpendicularly onto the length, respectively, can be considered a width of the particle. The resulting dimensional ratios will be maintained in case of majority (more than 50%, usually more than 85%) of the value of the natural material, whereby it is not impossible that the remaining part of the particles of the natural material will not meet this criteria. The meeting of the dimensional and ratio criteria for the separate particles of the natural material will be affected by the technology of the preparation and choice of the particles of the natural material, for example by the choice of milling and sifting.

An arrangement proved preferable where a volume content of the natural material in the resulting synthetic fiber ranges from 1% to 15%, eventually this volume content concerns precisely those particles of the natural material which meet the abovementioned dimensional ratios.

The terms “diameter” or “dimension” of the resulting synthetic fiber in this text denotes a diameter or a dimension of a synthetic fiber in a zone which is not affected by the particle of the natural fiber; it is thus the prevailing diameter or dimension of the synthetic fiber, into which this synthetic fiber is fiberized from the melt. The actual dimension of the synthetic fiber in a place where from its surface a part of the particle of the natural material protrudes can be larger than the diameter of the synthetic fiber in the majority of its length; in such places the outer dimension of the synthetic fiber with the protruding particle of the natural material will be defined by the dimension and orientation of the particle of the natural material. In such case the term “diameter” or “dimension” of the resulting fiber is understood as a diameter or dimension measured next to the protruding particle of the natural material.

The shapes and dimensions of the particles of the natural material according to this invention cause that the surface of the synthetic fiber is affected (influenced) by the presence of the particle in the respective place without complete interruption of the polymer basis in the direction of the fiber. The influence is manifested mainly by violation of the smooth surface of the synthetic fiber. The particle causes a deformation of the surface and/or it protrudes by its part from the surface and/or causes the creation of an opening on the surface of the synthetic fiber, whereby the opening from the surface runs inside where it is delimited by the surface of the particle inside the synthetic fiber. All mentioned manifestations form surface irregularities which lead to new use values of the synthetic fibers. When using particles of the natural material according to this invention the synthetic fiber has at least one surface irregularity on the length of the synthetic fiber, where the length is five times the cross-sectional diameter of the synthetic fiber.

The dimensional ratios between the particles of the natural material and the dimensions of the fiber have important effect on the essential features of the resulting synthetic fiber. Multiple volume or mass ratios of the added natural material are known in the prior state of the art. But without the linkage of the size of the particles of added material to the dimensions of the resulting fiber the added natural material is used very ineffectively; the majority of this material is as if closed, shut (or as if drowned) inside the fiber, where it worsens the mechanical characteristics, mainly tensile strength, but it does not add desired characteristics to the resulting fiber. When adding natural material according to the state of the art, the particles of the natural material get to the surface of the resulting fiber only in small occurrences, basically randomly in forms of endings of the fibers of the natural material. The increase of the volume of the natural material with goal of increasing the occurrence of the particles of the natural material on the surface of the resulting fiber pursuant to state of the art technically leads to worsening of its mechanical features, eventually even to snapping of the fiber during the production or processing. Contrary to this the arrangement according to this invention leads to significant increase of the influence of the natural material without the need to increase its share into a ratio which worsens other, mainly mechanical features.

The majority of these synthetic fibers with a polymer basis has a circular cross-section which originates in pulling, prolonging of the fiber from the material in a plastic state. The particles of the natural material are produced by milling (grinding), the necessary fractions are separated by sifting. The microscopic shape of the particles is affected mainly by the physical basis of the natural material and the technology of milling which is used. Hemp, jute, linen, cotton, sisal, kenaf, wood, cellulose, lignocellulose, coconut, nut shells, starch, wheat, zeolite can be used as a natural material. The natural material is cleaned and milled into desired fraction.

The particles of the natural material according to this invention basically do not have a fiber nature, but they are formed by separate splinters. During the preparation of the natural material no significant fiberization takes place, but there is milling and repeated breaking into smaller particles. Thanks to this the particles have a shape which better protects the core of the natural material before degradation than as is common with the fiberized form of the natural material.

The connection of the synthetic basis with the natural material has been hitherto based on the fiberization of the natural material of various types and such fibers of various length have been produced into the synthetic basis. When pulling the fiber the natural material has been oriented in the direction of pulling and it has been exposed to high temperature on the large surface, which led to degradation of the original characteristics of the natural material. The synthetic fiber according to this invention involves a natural material in the non-fiberized form, where the larger dimension of the particle does is not larger than four times the smaller dimension of the particle. At the same time the larger dimension of the particle is comparable with the diameter of the synthetic fiber. Thanks to this the particles in the resulting synthetic fiber can orient themselves in a varying direction. With a volume share more than 0.5%, preferably more than 1%, at least part of the particles gets close to the surface of the synthetic fiber through statistical-random distribution, which influences the surface, mainly it violates the integrity of the surface. The dimensional limitations will hold for the statistically significant part of the natural material; it is possible that the smaller part of the natural material will have a form of fibers or particles with the different dimensional parameters. The dimensional features of the particles can be distributed within the abovementioned limits according to Gaussian curve, for example.

During the prolongation of the synthetic fibers the basic material in the plastic state flows; during the pulling its cross-sectional profile diminishes. The particles of the natural material, however, during this plastic transformation behave basically as solid alien bodies; synthetic material is bound with the particles of the natural material by adhesive forces which transfer the shear stresses during plastic transformation, but the particles of natural material basically do not deform themselves. Thanks to this mechanism during the prolonging of the synthetic fiber part of the surface of the particle of the natural material gets to the vicinity of the outer surface of the synthetic material and this affects it in such a way that surface irregularity is produced on the surface of the synthetic fiber.

The described volume ratios between the basic mass (matter) of the synthetic fiber and the natural material, as well as described dimensional ratios of the particle of the natural material in relation to the dimensions of the resulting synthetic fiber are important so that there is no physical disintegration, separation of the synthetic fiber, but at the same time that there is a common occurrence of the surface irregularities.

A whole range of polymers proved preferable for the production of the synthetic fiber according to this invention. Preferably the synthetic polymer component includes at least one thermoplastic polymer. For example, polyolefin, such as polyethylene PE or polypropylene PP, can be used. An acrylic polymer such as polyacrylonitrile PAN can be used. Polyamide, such as nylon 6 or nylon 66, or polyester, such as polyethylene terephthalate PET, can be used. The basic synthetic polymer component can be present in all amounts ranging from cca. 60 to 97.5% of the mass, preferable from cca. 80 to 97% of the mass, relative to the overall mass of the semisynthetic material. A mixture of the polymers can be included in the synthetic polymer component.

In order to protect particles of the natural material against degradation during higher temperature and pressure it is preferable to use a modifier in the volume share 2 to 15% of the resulting mixture. As a modifier one can use linearily reactive polydimethylsiloxane and/or amide wax of the N,N-bis-stearyl-ethylenediamine type and/or the magnesium ionomer of the ethylene acrylic acid copolymer and/or ferric orthophosphate. It is also preferable to add a UV stabilizer to the synthetic material mixture, for example a mixed higher fatty acid ester and 2,2,6,6-tetramethylpiperidinol.

The deficiencies in the prior state of the art are significantly remedied by the method of production of the synthetic fiber, too, which involves a fiberization of the melt during the temperature ranging from 150° C. to 240° C. according to this invention which essence lies in the fact that a natural material in the resulting volume ranging from 0.5% to 45% is added to the melt before fiberization; the natural material has a form of the milled (grinded) particles where the larger dimension of the particle of the natural material has a value ranging from 10% to 120% of the cross-sectional diameter of the resulting synthetic fiber and a smaller dimension of the particle of the natural material has a value ranging from 25% to 75% of the larger dimension of the particle, whereby it does not surpass 50% of the cross-sectional diameter of the resulting synthetic fiber and subsequently the mixture of the basic material and the particles of the natural material is mixed for at least 5 minutes, preferably 15 minutes. In order to decrease the ratio of degradation of the particles of the particles of the natural material, the temperature of the fiberization of the melt will be under 200° C., whereby the choice of the basic synthetic material as well as of eventual modifiers will adjusted to this.

A counter-current mixing has proved preferable, where the mixture of the melted synthetic material flows from at least two directions oriented against each other to the common space where the turbulent and essentially randomly directed mixing of the individual flows takes place.

After sufficiently homogenous distribution of the particles of the natural material in the basic synthetic mass is achieved, the melt is fiberized by the common method. This is also the advantage of the proposed invention, which does not require special or different machine device. The disclosed ratios and sizes of the particles of the natural material do not cause significant worsening of the technological flow of the production.

The natural material is milled into the desired fraction before mixing to the melted basic synthetic material. Since various fractions result from the milling, it is preferable if the particles of the natural material are separated on the sieves with a varying sizes of the eyes.

The surface irregularities of varying type which are produced by means of the natural material according to this invention cause a significant bettering of multiple features of the synthetic fiber and subsequently of the textile or cloth woven from this synthetic fiber, too. The synthetic fibers according to this invention have excellent thermal insulation characteristics, they excellently lead away fluids and sweat, they are light, durable and cheap, and allow for usage of the recycled sources from the raw materials. They are also pleasant to touch, they feel good on the skin, they are not electrostatic and do not cause skin allergic reactions, and they eliminate the smells well. The capturing of smells is significantly higher than in cases of known fibers, thanks to which the textile or cloth from the fibers according to this invention can be preferably used for underwear. The irregular surface of the fibers according to this invention prevents the production of the static charge which improves the feeling of the user. Weaving and other processing of the synthetic fibers according to this invention is unlimited and hitherto existing technologies can be used. Preferable natural features of the resulting synthetic fiber is achieved already with the relatively small share of the natural material, since this, thanks to the preferable granulometry, significantly influences the surface layers and zones of the synthetic fiber. The surface irregularities of the synthetic fiber bring about features which are known in purely natural fibers.

### BRIEF DESCRIPTION OF DRAWINGS

The invention is further disclosed by FIGS. 1 to 6. The depicted diameter of the sizes and thicknesses is only illustrative. The dimensional ratios on the figures cannot be interpreted as limiting the scope of protection.

FIG. 1 depicts a view of the synthetic fiber pursuant to the state of art without added particles of the natural material, where a smooth, direct surface of the synthetic fiber is visible. One other fiber is added in order to increase clarity.

FIG. 2 depicts a synthetic fiber with particles of the natural material. One other fiber is added in order to increase clarity. The dashed line depicts part of the particle which is inside the cross-section of the fiber. Enlarged particle with the marked up dimensions is depicted below the fiber.

FIG. 3 is a sectional view of the synthetic fiber in the place of the particle from the natural material. In the lower part of the picture an enlarged particle with marked up dimensions is depicted.

Table on the FIG. 4 depicts the dependency of the prolongation of the synthetic fiber on the fineness at various densities of the synthetic material. Axis y marks the value of the size of the particles in pm.

FIGS. 5 to 6 are photographs of the synthetic fibers under microscope.

FIG. 5 is a synthetic fiber according to the state of the art without added particles of the natural material.

FIG. 6 is a synthetic fiber with the protruding particles of the natural material.

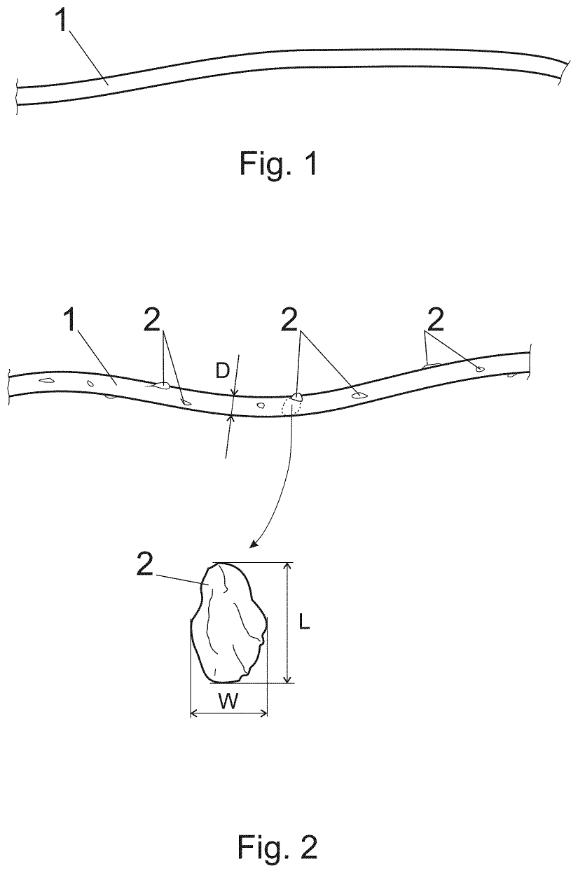

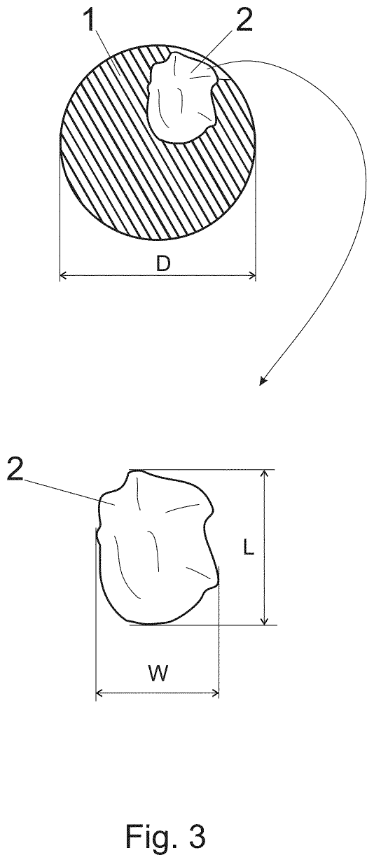

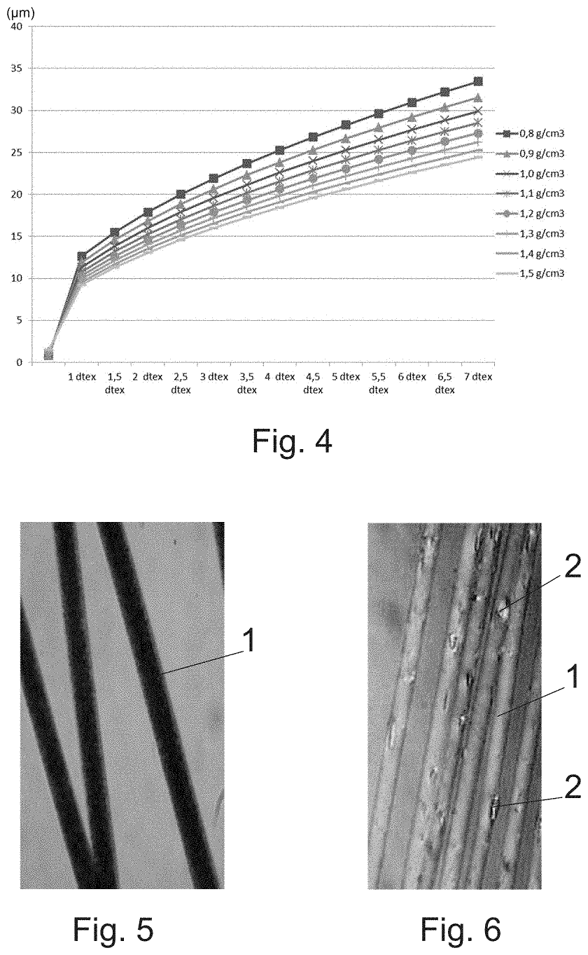

### EXAMPLES OF REALIZATION

### Example 1

In this example according to drawings 2 to 4, 6 polyamide PA is used as a basic synthetic material; it forms 90% of the volume of the resulting mass of the synthetic fiber 1. In the mill a cellulose is milled or crushed and from the crushed matter the particles 2 with size ranging from 8 to 12 μm are selected on the sieves. The size of the particles 2 ranging from 8 to 12 μm corresponds to length L; the width W of the particles 2 ranges from 4 to 9 μm, which is between 25% to 75% of the length of the particle 2.

The particles 2 of the natural material are added to the melted synthetic material, whereby the amide wax of the N,N-bis-stearyl-ethylenediamine type (in this example under the brand Licowax C) in 2.5% of volume is added as dispersant, too.

The density of the mixture in the cold state is 1.12 g/cm³. The mixture of the synthetic material and the particles 2 of the natural material is mixed in the mixer for at least 5 minutes, preferably 15 minutes. The mixture is subsequently recast (melted again) in order to achieve greater homogenity. The melt is then fiberized on the line under standard conditions. In this example the prolongation into synthetic fibers 1 with dimensions 3-3.5 dtex takes place.

### Example 2

The mixture in this examples involves polypropylene in 92% of the volume and particles 2 from the natural material 2.5% of the mass, whereby the natural material in this example is a cellulose. The particles 2 have size 10-15 μm.

The preparation of the mixture and the method of production is similar to example 1. The density of the mixture in the cold state is 0.91 g/cm³. A linearly reactive polydimethylsiloxane (in this example under brand Tegomer E 525) forming 5.5% of the volume is used as modifier. The synthetic fiber 1 is prolonged to 3.5-4.0 dtex.

The particles 2 of the natural material are poured into the flowing melted mass of polypropylene PP and added modifier. The mixture is transferred (pumped) from the vessel with the circular groundplan. Jets are distributed in a single plane alongside the circumference of the vessel by its bottom, and they are radially oriented against each other towards the inside of the vessel. The melted mass flows through the jets into the vessel where intensive, turbulent mixing takes places, which causes the mixture to homogenize quickly.

### Example 3

The mixture involves polyproplyene PP in 93% of the volume and particles 2 of the natural material in 2% of the mass, whereby the natural material in this example a is cellulose. The particles 2 have size 5-8 μm.

The preparation of the mixture and the method of production is similar to example 1. The density of the mixture in the cold state is 0.92 g/cm³. A linearly reactive polydimethylsiloxane (in this example under brand Tegomer E 525) forming 5% of the volume is used as modifier. The synthetic fiber 1 is prolonged to 2.5 dtex.

### Example 4

The mixture involves polyethylene terephthalate PET in 93% of the volume and particles 2 of the natural material in 3.5% of the mass, whereby the natural material in this example is a cellulose. The particles 2 have size 5-8 μm.

The preparation of the mixture and the method of production is similar to example 1. The density of the mixture in the cold state is 1.37 g/cm³. An amide wax of the N,N-bis-stearyl-ethylenediamine type (in this example under the brand Licowax C) forming 3.5% of the volume is used as modifier. The synthetic fiber 1 is prolonged to 4.5 dtex.

### Example 5

The mixture involves polypropylene PP in 93% of the volume and particles 2 of the natural material in 2% of the mass, whereby the natural material in this example is a zeolite. The particles 2 have size 8-12 μm.

The preparation of the mixture and the method of production is similar to example 1. The density of the mixture in the cold state is 0.94 g/cm³. A linearly reactive polydimethylsiloxane (in this example under brand Tegomer E 525) forming 5% of the volume is used as modifier. The synthetic fiber 1 is prolonged to 5.5 dtex.

### Example 6

The mixture involves polyamide PA in 90% of the volume and particles 2 of the natural material in 7.5% of the mass, whereby the natural material in this example is a finely milled bamboo fiber. The particles 2 have size 8-12 μm.

The preparation of the mixture and the method of production is similar to example 1. The density of the mixture in the cold state is 1.15 g/cm³. An amide wax of the N,N-bis-stearyl-ethylenediamine type (in this example under the brand Licowax C) forming 2.5% of the volume is used as modifier. The synthetic fiber 1 is prolonged to 4.5 dtex.

### Example 7

The mixture involves polypropylene PP in 93% of the volume and particles 2 of the natural material in 7.5% of the mass, whereby the natural material in this example is a coconut fiber. The particles 2 have size 5-8 μm.

The preparation of the mixture and the method of production is similar to example 1. The density of the mixture in the cold state is 0.90 g/cm³. A linearly reactive polydimethylsiloxane (in this example under brand Tegomer E 525) forming 5% of the volume is used as modifier. The synthetic fiber 1 is prolonged to 2.5 dtex.

### Example 8

A textile cloth for clothing is woven from the synthetic fiber with the admixture of natural material. The clothing is thermal insulative, it excellently leads away sweat, it is pleasant to touch, it eliminates smells and it is antistatic.

### INDUSTRIAL APPLICABILITY

The industrial applicability is obvious. According to this invention it is possible to industrially and repeatedly produce and use synthetic fibers with the particles of natural material, whereby the cloth from these synthetic fibers have preferable characteristics combining the advantages of the synthetic fiber with advantages of the natural material.

### LIST OF RELATED SYMBOLS AND POSITIONS

1—synthetic fiber

2—particle

L—length

W—width

D—diameter

1. A synthetic fiber with an admixture of a natural material, where the synthetic fiber (1) comprises: a polymer in form of a fiberized basic material and where the natural material has a form of separate particles (2) which are present in the basic material;
a volume content of the natural material in a resulting volume of the synthetic fiber (1) ranges from 0.5% to 45%,
the particles (2) have a shape where a length (L) is different from a width (W), the length (L) of the particle (2) of the natural material ranges from 10% to 120% of a cross-sectional diameter (D) of the resulting synthetic fiber (1),
wherein the width (W) of the particle (2) of the natural material ranges from 25% to 75% of the length (L) of the particle (2), and
wherein the width (W) of the particle (2) is less or equal 50% of the cross-sectional diameter (D) of the synthetic fiber (1).

2. The synthetic fiber with the admixture of the natural material according to claim 1, wherein the length (L) of the particle (2) of the natural material ranges from 30% to 80% of the cross-sectional diameter (D) of the resulting synthetic fiber (1).

3. The synthetic fiber with the admixture of the natural material according to claim 1, wherein the volume content of the natural material in the resulting volume of the synthetic fiber (1) ranges from 1% to 15%.

4. The synthetic fiber with the admixture of the natural material according to claim 1, wherein the fiber has at least one surface irregularity caused by the particle (2) on a length of the synthetic fiber (1), whereby this length is five times the diameter (D) of the synthetic fiber (1).

5. The synthetic fiber with the admixture of the natural material according to claim 1, wherein the particles (2) are milled.

6. The synthetic fiber with the admixture of the natural material according to claim 1, wherein the natural material is at least one of a hemp, a jute, a linen, a cotton, a sisal, a kenaf, a wood, a cellulose, a lignocellulose, a coconut, nut shells, a starch, and a wheat.

7. The synthetic fiber with the admixture of the natural material according to claim 1, wherein the natural material is a zeolite.

8. The synthetic fiber with the admixture of the natural material according to claim 1, wherein the synthetic material is at least one thermoplastic polymer.

9. The synthetic fiber with the admixture of the natural material according to claim 8, wherein the synthetic material is a polyolefin.

10. The synthetic fiber with the admixture of the natural material according to claim 8, wherein the synthetic material is at least one of polyethylene PE, a polypropylene PP, a polyacrylonitrile PAN, a polyamide, and a polyethylene terephthalate PET.

11. synthetic fiber with the admixture of the natural material according to claim 1, further including a modifier in amount ranging from 2% to 15% of a resulting mass of the synthetic fiber (1), wherein the modifier is a linear reactive polydimethylsiloxane and/or an amide wax of an N,N-bis-stearyl-ethylenediamine type and/or a magnesium ionomer copolymer of an ethylene acrylic acid and/or a ferric orthophosphate.

12. A textile product with the synthetic fiber with the admixture of the natural material according to claim 1.

13. A method of a production of a synthetic fiber comprising the steps of:
fiberization of a melt at a temperature ranging from 150° C. to 240° C.,
adding a natural material forming 0.5% to 45% of a resulting volume to the melt before the fiberization; the natural material has a form of milled particles (2) where a length (L) of the particle (2) ranges from 10% to 120% of a cross-sectional diameter (D) of the resulting synthetic fiber (1) and a width (W) of the particle (2) ranges from 25% to 75% of the length (L) of the particle (2), whereby the width (W) of the particle (2) does not surpass 50% of the cross-sectional diameter (D) of the resulting synthetic fiber (1), and subsequently a mixture of a synthetic material and the particles (2) of the natural material is mixed for at least 5 minutes.

14. The method of production of the synthetic fiber which involves the fiberization of the melt according to claim 13, wherein the melt is fiberized at the temperature less than 200° C.

15. The method of production of the synthetic fiber which involves the fiberization of the melt according to claim 13, wherein the mixture of the synthetic material and the particles (2) of the natural material is mixed in such a way that the mixture of the melted synthetic material flows into a common space from at least two directions oriented against each other, whereby a turbulent mixing of individual flows takes place in this common space.
